(19) United States
(12) Patent Application Publication
(10) Pub. No.: US 2012/0086797 A1
(43) Pub. Date: Apr. 12, 2012

(54) METHOD OF DETECTING PATTERN FORMED ON NON-EXPOSED SURFACE OF WORKPIECE

(75) Inventor: Kenji Furuta, Ota-Ku (JP)

(73) Assignee: DISCO CORPORATION, Tokyo (JP)

(21) Appl. No.: 13/269,364

(22) Filed: Oct. 7, 2011

(30) Foreign Application Priority Data
Oct. 8, 2010 (JP) 2010-229102

(51) Int. Cl. H04N 7/18

(52) U.S. Cl. 348/87; 348/E07.085

(57) ABSTRACT

A method of detecting an object of detection formed in the inside of or on a non-exposed surface of a workpiece having a rugged exposed surface, the detection being made on the exposed surface side of the workpiece by use of an imaging unit. The detecting method includes: a flattening step of coating the exposed surface of the workpiece with a liquid resin transmissive to the wavelength of light to be detected by the imaging unit so as to flatten the exposed surface of the workpiece; and a detecting step of detecting the object of detection formed in the inside of or on the non-exposed surface of the workpiece by use of the imaging unit on the exposed surface side of the workpiece coated with the liquid resin, after the flattening step.

### BACKGROUND OF THE INVENTION

1. Field of the Invention

The present invention relates to a method of detecting an object of detection, such as a pattern, which is formed in the inside of or on a non-exposed surface of a workpiece such as a semiconductor wafer.

2. Description of the Related Art

In a semiconductor device manufacturing process, a plurality of regions are demarcated by planned dividing lines, called streets, which are arranged in a grid form on a surface (face side) of a workpiece having a roughly circular shape, and circuits such as ICs and LSIs are formed in the thus demarcated regions. Then, the workpiece is cut along the planned dividing lines to divide the workpiece into the regions provided with the circuits, whereby individual semiconductor chips are manufactured.

The cutting of the workpiece along the streets is conducted by, for example, a cutting apparatus called dicer. In operation of the cutting apparatus, a special pattern in each of the rectangular chip regions demarcated by the streets (for example, a pattern added for recognition of the center position of the chip region) is set as an object of detection, and the pattern is detected through image processing while imaging, in a scanning manner by an imaging means, the exposed surface of the semiconductor wafer to be divided. Then, based on the thus detected pattern and a prestored positional relationship between the streets and the pattern as the object of detection, the streets are recognized and the workpiece is cut along the streets thus recognized.

Such a pattern detecting method is effective in the case where that side of the workpiece on which the patterns are formed is exposed. However, in the case where the workpiece is reversed face side back before being cut or in the case of cutting a special workpiece provided with patterns in the inside thereof, the pattern detection cannot be achieved by the above-mentioned pattern detecting method. In view of this, the present inventor has developed an imaging means by which, for example in the case where the workpiece is a silicon wafer, a non-exposed surface or the inside of the semiconductor wafer can be imaged on the exposed surface side by utilizing the silicon's property of being transmissive to infrared rays (see Japanese Patent Laid-open No. Hei 7-75955).

### SUMMARY OF THE INVENTION

When the exposed surface of the workpiece is rugged, however, imaging and detection of the pattern as an object of detection has been impossible to perform, even by use of imaging means having sensitivity at a wavelength of light which can be transmitted through the workpiece. Specifically, when a pattern is focused on through a lens as indicated by dot-dash line in FIG. 10, an image of the pattern can be formed in a CCD camera and, therefore, the imaging can be achieved. In the case where imaging is performed by use of a low-magnification lens having a large focal depth, however, focusing on a pattern formed in the inside of a workpiece or formed on a non-exposed surface on the side opposite to an exposed surface of a workpiece would, even if achieved, result in that the ruggedness of the exposed surface of the workpiece is also imaged, so that the image of the pattern is blurred. Besides, in the case where imaging is conducted by use of a high-magnification lens having a small focal depth, even if a pattern in the inside of or on a non-exposed surface of a workpiece is focused on, light would be scattered due to the ruggedness of the non-exposed surface of the workpiece as indicated by arrows A3 in FIG. 10, again resulting in blurring of the image of the pattern.

In view of the foregoing, it is an object of the present invention to provide a detection method by which it is ensured that, even in the case of a workpiece having a rugged exposed surface, an object of detection such as a pattern formed in the inside of or on a non-exposed surface of the workpiece can be detected by imaging from the exposed surface side.

In accordance with an aspect of the present invention, there is provided a method of detecting an object of detection formed on a non-exposed surface of a workpiece having a rugged exposed surface, the detection being conducted from the exposed surface side of the workpiece by use of an imaging means, the method including: a flattening step of coating the exposed surface of the workpiece with a liquid resin transmissive to wavelength of light to be detected by the imaging means and curing the resin so as to flatten the exposed surface of the workpiece; and a detecting step of detecting the object of detection formed on the non-exposed surface of the workpiece by use of the imaging means from the exposed surface side of the workpiece coated with the liquid resin which is cured, after the flattening step.

According to the present invention, the exposed surface being rugged of the workpiece is coated with a liquid resin (which is transmissive to the light with the wavelength transmitted through the workpiece to be detected by the detecting means and of which the refractive index at the wavelength is close to that of the workpiece), whereby the exposed surface of the workpiece is flattened by the cured product of the liquid resin, the degree of refraction of the light at the interface between the exposed surface of the workpiece and the cured resin can be lowered and the light can be transmitted therethrough. As a result, scattering of light due to ruggedness of the exposed surface of the workpiece can be lowered, and the pattern formed in the inside of or on a non-exposed surface of the workpiece can be imaged while being focused on. Therefore, it is possible to suppress, as compared with the related art, the blurring of the image obtained when an object of detection such as a pattern formed in the inside of or on a non-exposed surface of a workpiece having a rugged exposed surface is detected.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a schematic perspective view illustrating the configuration of a silicon wafer and the configuration of a major part of a cutting apparatus for cutting the silicon wafer along streets;

FIG. 2 is a perspective view illustrating, by extraction, the configuration of a cutting means shown in FIG. 1 and the surroundings thereof;

FIG. 3 is a schematic perspective view illustrating a storage position for a chuck table constituting a coating means shown in FIG. 1;

FIG. 4 illustrates the configuration of an imaging means shown in FIG. 1;

FIG. 5 is an illustration of a detecting step;

FIG. 6 illustrates an example of a workpiece to which the detection method according to the present invention is applied;

FIG. 7 illustrates an example of another workpiece to which the detection method according to the present invention is applied;

FIG. 8 shows image examples of an imaged pattern of the workpiece shown in FIG. 6;

FIG. 9 shows image examples of an imaged pattern of the workpiece shown in FIG. 7; and

FIG. 10 is an illustration of a problem in the prior art.

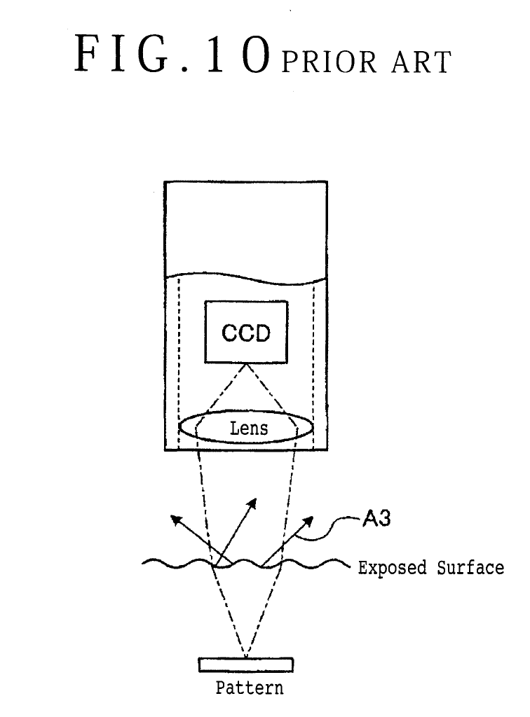

### DETAILED DESCRIPTION OF THE PREFERRED EMBODIMENT

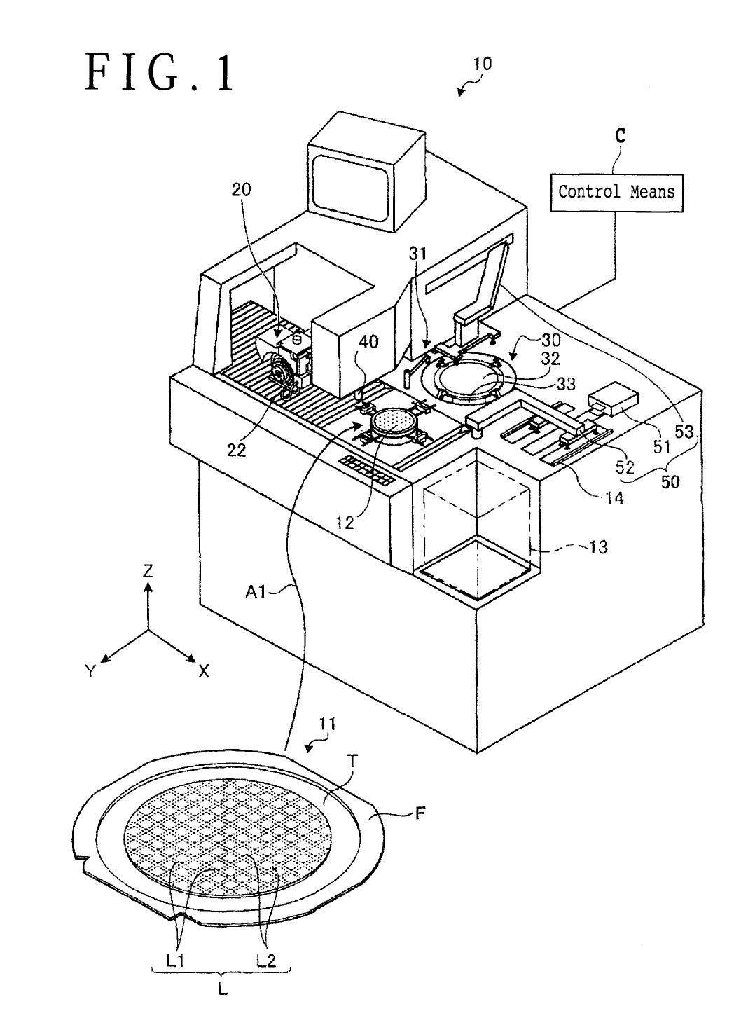

Now, an embodiment of the detection method according to the present invention will be described below referring to the drawings. Incidentally, the present invention is not to be restricted by the embodiment. FIG. 1 is a schematic perspective view illustrating the configuration of a silicon wafer 11, which is an example of the workpiece, and the configuration of a major part of a cutting apparatus 10 for cutting the silicon wafer 11 along streets by applying the detection method according to the present invention. As shown in FIG. 1, the silicon wafer 11 as an object of detection in the present embodiment has a roughly circular shape, its face side is demarcated in a grid form by orthogonally intersecting planned dividing lines L (L1, L2) as indicated by broken lines in FIG. 1, and devices (in the present embodiment, a pattern in each device is the object of detection) are formed in the regions thus demarcated. In addition, the back side of the silicon wafer 11 is minutely rugged. Besides, in the present embodiment, the silicon wafer 11 is accompanied by a holding tape (pressure sensitive adhesive tape) T adhered to its face side on which the devices are formed, so that the face side is a non-exposed surface and the back side is an exposed surface.

Incidentally, a specific example of the workpiece is not restricted to the silicon wafer. Thus, specific examples of the workpiece further include such semiconductor wafers as gallium-arsenic (GaAs) wafer, etc., pressure sensitive adhesive members such as DAF (die attach film) provided on the back side of a wafer for chip mounting, etc., packages of semiconductor products, substrates of inorganic material such as ceramic, glass, sapphire (Al₂O₃), etc., various electronic parts such as LCD driver, etc., and various materials to be processed for which a processing positional accuracy on a micrometer order is required.

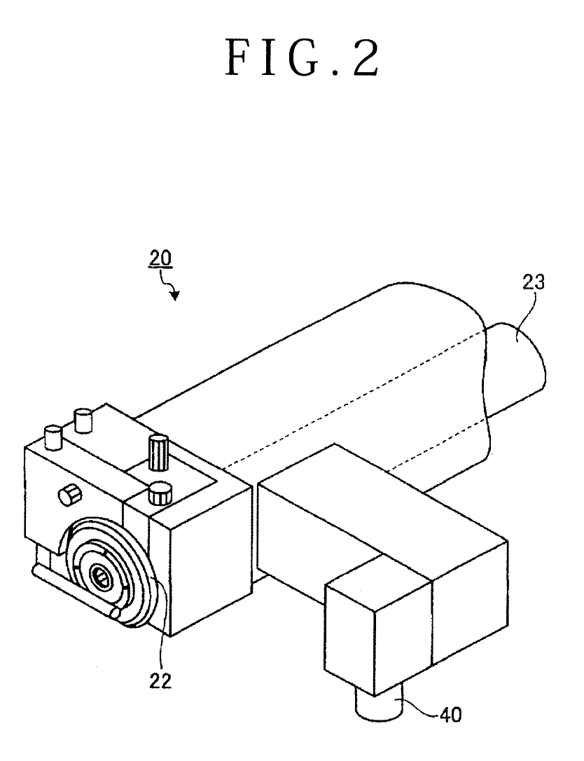

The cutting apparatus 10 includes cutting means 20, a chuck table 12, coating means 30, imaging means 40, cutting feeding means (not shown), moving means (not shown), feeding-in/out means 50, and control means C. As shown in FIG. 2, the cutting means 20 has a spindle unit 23 fitted with a cutting blade 22. The cutting blade 22 is, for example, a ring-shaped grinding wheel for cutting. The cutting means 20 can be moved relative to an object to be detected (workpiece) 11 while the cutting blade 22 is being rotated at a high speed by a rotational driving force of the spindle unit 23 and the cutting blade 22 is being made to cut the workpiece 11, whereby the workpiece 11 on the chuck table 12 is cut.

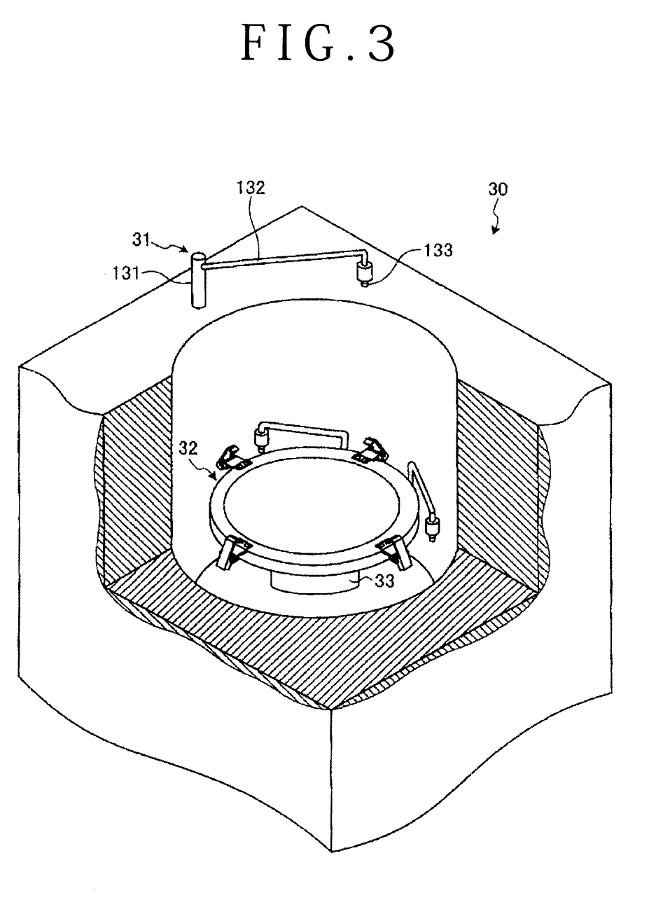

The chuck table 12 is formed, for example, of a porous material. The workpiece 11 in the state of being supported on a frame F by the holding tape T is fed in, along the direction indicated by arrow A1 in FIG. 1, by the feeding-in/out means 50, and is held onto the chuck table 12 by vacuum suction, for example. As for example shown in FIG. 3, the coating means 30 has coating material supply means 31 and chuck table 32. This chuck table 32 is for holding the workpiece 11 by suction, like the above-mentioned chuck table 12, and is disposed at the upper end of a cylindrical rotary section 33. The chuck table 32 can be rotated by the rotary section 33; specifically, the chuck table 32 can be rotated, with the vertical direction (Z-axis direction) as an axis of rotation, by a pulse motor or the like disposed inside the rotary section 33. In addition, the chuck table 32 is supported by a lift unit (not shown) through the rotary section 33 so that it can be moved up and down along the vertical direction (Z-axis direction). Consequently, the chuck table 32 is selectively positioned into a coating position where it is set to the height of a working plane of the cutting apparatus 10 and a storage position where it is stored inside the cutting apparatus 10.

The coating material supply means 31 has a support shaft 131 which is disposed in the vicinity of an aperture at the working plane of the cutting apparatus 10 and which is capable of rotation with the vertical direction as an axis of rotation, an arm 132 connected at one end thereof to the upper end side of the support shaft 131, and a nozzle 133 provided on the other end side of the arm 132 so as to have a jet port directed downward. In addition to these components, the coating material supply means 31 includes a coating material supply source, a pipe for leading a coating material from the coating material supply source to the nozzle 133, and so on. The coating material supply means 31 is so designed that, in a coating step to be described later, the arm 132 is rotated by rotation of the support shaft 131 so that the nozzle 133 is moved to a position over the vicinity of the center of the chuck table 32 positioned in the coating position, and the coating material is jetted from the nozzle 133, to be supplied to the rugged back side of the workpiece 11 held on the chuck table 32.

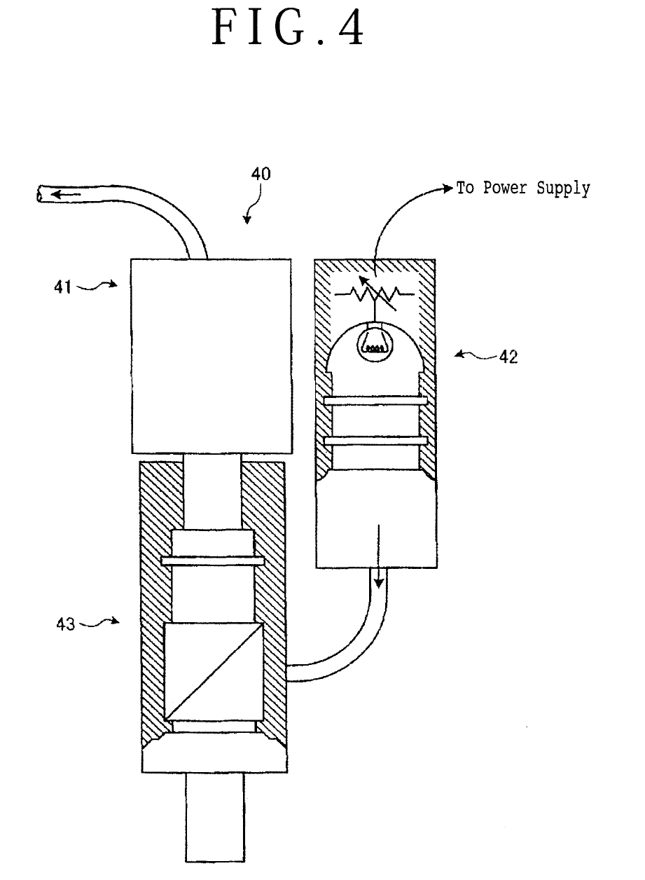

As for example shown in FIG. 4, the imaging means 40 has an infrared camera 40 having sensitivity in a wavelength region of infrared rays capable of being transmitted through silicon, an illumination device 42, and a microscope 43. As for example shown in FIG. 2, the imaging means 40 is fixed to a side portion of the spindle unit 23 constituting the cutting means 20, and is oriented downward (in a downward sense of the Z-axis in FIG. 1). In addition, the imaging means 40 and the cutting blade 22 are so disposed as to be arrayed linearly in the X-axis direction. By this imaging means 40, a pattern affixed to the workpiece 11 mounted on the chuck table 12 is imaged. At the time of imaging, infrared rays radiated from the illumination device 42 to the back side of the workpiece 11 are transmitted to the inside of the workpiece 11, are reflected by the face side of the workpiece 11, and are thereafter sent through the microscope 43 into the infrared camera 41, whereby imaging is performed.

The cutting feeding means is for relative movement of the chuck table 12 and the cutting means 20. By the cutting feeding means, an X-axis moving table can be moved in a cutting direction (namely, the X-axis direction). In addition, the moving means also is for relative movement of the cutting means 20 and the chuck table 12. By the moving means, the cutting means 20 can be moved in a Y-axis direction. Incidentally, by use of the cutting feeding means and the moving means, the imaging means 40 can be freely moved in the X-axis direction and the Y-axis direction.

The feeding-in/out means 50 is for feeding in/out the workpiece 11 at the time of taking the workpiece 11 out of a wafer storage position 13 and placing it on the chuck table (12, 32) and at the time of returning the processed workpiece 11 into the storage position. The feeding-in/out means 50 includes wafer feeding-in/out means 51, a slewing arm 52, feeding means 53 and the like. The workpiece 11 before coated with the coating material by the coating means 30 is taken out by the wafer feeding-in/out means 51 from the wafer storage position 13, where it is fitted with the frame F, to a feeding-in/out region 14, and is positioned to the position of the chuck table 32 of the coating means 30 by the slewing arm 52. In addition, the workpiece 11 coated with the coating material as the liquid resin by the coating means 30 is fed to the position of the chuck table 12 by the feeding means 53.

The cutting apparatus 10 cuts the workpiece 11 placed on the chuck table 12 and held thereon by suction. In this instance, before cutting, first, alignment of the street (planned dividing line) along which cutting is to be performed and the cutting blade 22 with each other in the Y-axis direction is conducted. At the time of the alignment, the pattern is detected by a detection process to be described later, and the planned dividing line L is recognized based on a prestored positional relationship between the pattern as the object of detection and the planned dividing line, after which cutting is conducted by moving the chuck table 12 in the X-axis direction by the cutting feeding means. When cutting along one planned dividing line L is finished, the cutting blade 22 is aligned to a cutting line adjacent (next) to the one planned dividing line L in the Y-axis direction, and cutting is conducted. In this manner, alignment of the cutting blade 22 and cutting of the workpiece 11 are conducted repeatedly, whereby cutting of the workpiece 11 in one direction is carried out.

The cutting apparatus 10 configured as above has the control means C for controlling operations of components of the cutting apparatus 10 so as to totally control the cutting apparatus 10. The control means C is composed of a microcomputer or the like which incorporates a memory for storing various data necessary for operations of the cutting apparatus 10. Under the control of the control means C, the cutting apparatus 10 performs a flattening step and a detecting step.

Now, the flattening step according to the present embodiment will be described. The flattening step is a step of coating the back side of the workpiece 11, which has a rugged back side, with a coating material so as to flatten the back side. The flattening step includes a holding step of positioning the workpiece 11 into a coating position of the coating means 30 and a coating step of coating the surface (back side) of the workpiece 11 with the coating material.

### (Holding Step)

In the coating means 30, the lift unit (not shown) lifts up the chuck table 32 to position it in the coating position, and the feeding-in/out means 50 feeds in the workpiece 11, with the surface to be coated (back side) kept up, to the position of the chuck table 32 and places the workpiece 11 on the chuck table 32. Then, the suction means (not shown) of the chuck table 32 is driven to hold the workpiece 11 on the chuck table 32 by suction. As a result, the workpiece 11 is held so that its rugged back side is exposed. Besides, in this holding step, the coating material supply means 31 is driven, and the support shaft 131 is rotated to turn the arm 132, whereby the nozzle 133 is moved to a position over the vicinity of the center of the holding surface of the chuck table 32.

### (Coating Step)

In the subsequent coating step, the coating material supply means 31 is driven, and a predetermined amount of liquefied PVA (polyvinyl alcohol) as an example of the coating material is jetted from the nozzle 133, whereby the liquid coating material is supplied to the rugged back side of the workpiece 11 held on the holding surface of the chuck table 32. Subsequently, the lift unit (not shown) is driven to lower the chuck table 32, whereby the chuck table 32 is positioned in the storage position. Thereafter, the rotary section 33 is driven to rotate the chuck table 32 at a predetermined rotating speed for a predetermined time, whereby the coating material is spread over the whole area of the rugged back side of the workpiece 11 under a centrifugal force. The rotating speed and the rotation time of the chuck table 32 are set appropriately according to the film thickness of the coating material desired.

The film thickness of the coating material can also be appropriately set. It is to be noted here that if the thickness is too small, the ruggedness cannot be absorbed, and if the thickness is too large, the coating material would absorb light. Therefore, the film thickness of the coating material is desirably a minimum thickness that is necessary for flattening the ruggedness of the back side of the workpiece 11. Though depending on the surface condition of the back side of the workpiece 11, the film thickness of the coating material is preferably, for example, 0.5 to 3.0 μm, more preferably 0.8 to 1.5 μm. The liquid coating material is cured with the lapse of time, and a coating film of the coating material is formed in a desired film thickness over the whole area of the rugged back side of the workpiece 11, whereby the rugged back side is flattened. Incidentally, a major portion of the coating material supplied to the back side of the workpiece 11 is scattered to the outside of the workpiece 11 by the centrifugal force arising from the rotation of the chuck table 32. Since the chuck table 32 is positioned in the storage position inside the housing of the cutting apparatus 10, however, the coating material would not be scattered to the exterior of the housing.

Now, the detecting step according to the present embodiment will be described. In the detecting step, the device(s) as the pattern formed on the face side of the workpiece 11 is detected. The workpiece 11 has been fed by the feeding-in/out means 50 to the chuck table 12, and held on the holding surface of the chuck table 12 so that its back side coated with the coating material is exposed. Therefore, the device(s) on the face side of the workpiece 11 on the holding surface is imaged using light transmitted through the workpiece 11 from the back side of the workpiece 11 by use of the imaging means 40, and image data thus obtained is subjected to image processing such as pattern matching, to thereby detect the pattern.

Incidentally, while the infrared camera is used depending on the silicon wafer in the present embodiment, this is not restrictive, insofar as the pattern in the inside of or on a non-exposed surface of the workpiece 11 can be detected. Therefore, for example, a visible-light camera or the like can be used through appropriate selection according to the kind of the workpiece 11. Specifically, while the infrared camera is used in the case of the silicon wafer, the visible-light camera can be used for a wafer of a material transmissive to visible light, such as sapphire.

After the pattern is detected by the detecting step as above, the planned dividing line L is recognized based on that positional relationship between the pattern as the object of detection and the planned dividing lines which has preliminarily been stored in the memory. Then, the planned dividing line as the object of processing is positioned just under the cutting blade 22, and cutting is conducted along the planned dividing line L.

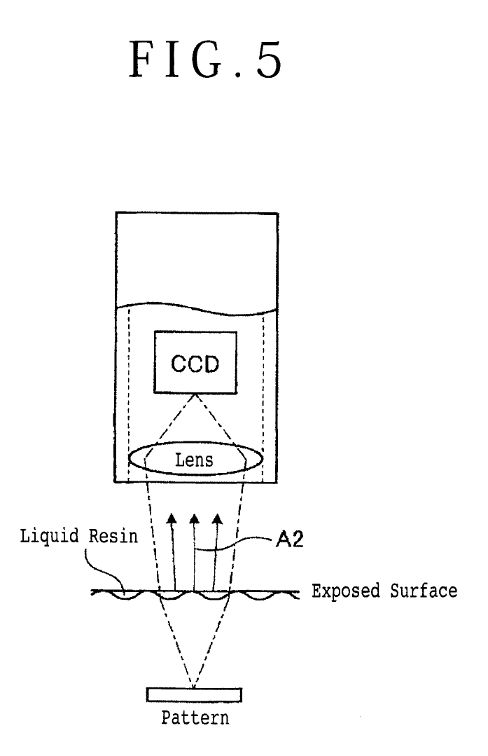

According to the method as above-described, the back side of the workpiece 11 with the back side rugged is flattened by the cured product of the liquid resin (which is transmissive to the light of the wavelength transmitted through the workpiece to be detected by the imaging means and which has a refractive index close to that of the workpiece 11). This ensures that the degree of refraction of light at the interface between the back side of the workpiece 11 and the cured resin is lower than the degree of refraction at the interface between the back side of the workpiece 11 and air, whereby the light can be transmitted smoothly through the former interface, and scattering of light on the back side of the workpiece 11 can be restrained, as illustrated in FIG. 5. Specifically, in FIG. 5, when the pattern is focused on through the lens as indicated by dot-dash line, an image of the pattern is formed in the CCD camera, in other words, imaging of the pattern is achieved. In this case, since the back side of the workpiece 11 is flattened by the coating material, infrared rays are transmitted in the manner of being restrained from obstructing the formation of image of the pattern, as indicated by arrows A2. Accordingly, from the side of the rugged back surface of the workpiece 11, the pattern as the object of detection present in the inside of or on the non-exposed surface of the workpiece 11 can be imaged and detected more clearly, as compared with the case where the rugged back surface is not coated with the coating material.

In addition, according to the present embodiment, the coating material applied to the rugged back side of the workpiece 11 forms a protective film, which functions to protect the rugged back side of the workpiece 11 against chips (swarf). Besides, after the cutting of the workpiece 11, the coating material is washed away by use of a washing liquid according to the kind of the coating material. In the present embodiment, PVA (polyvinyl alcohol) which is soluble in water is used as the coating material, and, therefore, washing with water after the cutting is sufficient for simultaneously removing the coating material and the chips (swarf).

Incidentally, while the blade dicing saw is mentioned as an example of the cutting apparatus 10 in the present embodiment, the detection method according to the present invention is similarly applicable to a laser beam machine. The liquid resin may be any liquid resin such that the difference between the refractive index of the resin and the refractive index of the workpiece 11 is smaller than the difference between the refractive index of air and the refractive index of the workpiece 11, with respect to the light of the wavelength to be detected by the imaging means 40.

For instance, in the case where the inside of or a non-exposed surface of the silicon wafer 11 is imaged from the exposed surface side by use of an imaging means 40 designed to detect an infrared wavelength (for example, around 800 to 900 nm) as in the present embodiment, when the refractive index of air (0° C., 1 atm) for the infrared wavelength is considered to be about 1.0 and the refractive index of silicon being around 4.0 is taken into account, it is considered that detection accuracy can be enhanced by adopting a liquid resin which has a refractive index of roughly not less than 1.0 and less than 7.0 for the infrared wavelength. Examples of the liquid resin which can be used here include polyimides, optical plastics, and PVA (polyvinyl alcohol). Naturally, a higher detection accuracy can be expected as the refractive index of the liquid resin approaches 4.0.

In addition, in the case where the inside of or a non-exposed surface of a sapphire wafer is imaged from the exposed surface side by use of an imaging means 40 designed to detect light of a visible wavelength (for example, around 380 to 770 nm), when the refractive index of air (0° C., 1 atm) for the visible wavelength is considered to be about 1.0 and the refractive index of sapphire being around 1.8 is taken into account, it is considered that detection accuracy can be enhanced by adopting a liquid resin which has a refractive index of roughly not less than 1.0 and less than 2.6. Examples of the liquid resin which can be used here include polyimides, optical plastics, and PVA (polyvinyl alcohol). Naturally, a more enhanced detection accuracy can be expected as the refractive index of the liquid resin approaches 1.8.

Besides, the present invention is applicable also to the case where a pattern in a work piece 11 provided thereon with a dicing tape or the like satin-finished on the back side is detected through the tape or the like. In this case, the satin-finished surface of the tape as an exposed surface is coated with the liquid resin, before imaging the pattern. As for the film thickness of the coating on the satin-finished surface of the tape, if the film thickness is too small, the ruggedness of the satin-finished surface cannot be absorbed satisfactorily, and if the film thickness is too large, light is absorbed by the coating material. Therefore, it is desirable that the film thickness of the coating is 0.5 to 10 μm, preferably 0.5 to 7 μm, more preferably 0.5 to 5 μm.

In the case of imaging the pattern in the workpiece 11 through the tape, it suffices to use a liquid resin such that the difference between the refractive index of the resin and the refractive index of the tape is smaller than the difference between the refractive index of air and the refractive index of the tape, with respect to the light of a wavelength to be detected by the imaging means 40. For instance, in the case where a pattern in a workpiece is imaged through a tape formed of PVC (polyvinyl chloride) or the like transmissive to visible light by use of an imaging means designed to detect light of a visible wavelength (for example, around 380 to 770 nm), when the refractive index of air (0° C., 1 atm) for the visible wavelength is considered to be about 1.0 and the refractive index of the tape being about 1.4 to 1.7 is taken into account, it is considered that processing accuracy can be enhanced by adopting a liquid resin having a refractive index of generally not less than 1.0 and less than 2.0. Examples of the liquid resin which can be used here include polyimides, optical plastics, and PVA (polyvinyl chloride). Naturally, a higher detection accuracy can be expected as the refractive index of the liquid resin approaches the refractive index of the tape used.

### Example

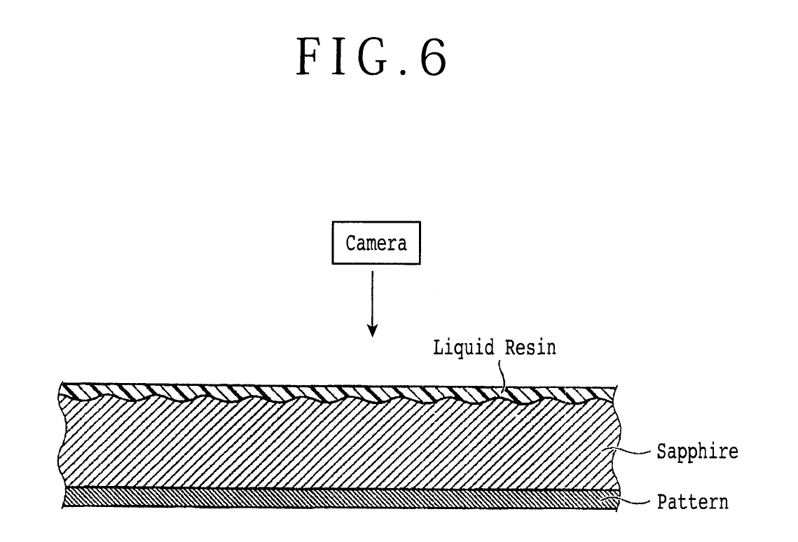

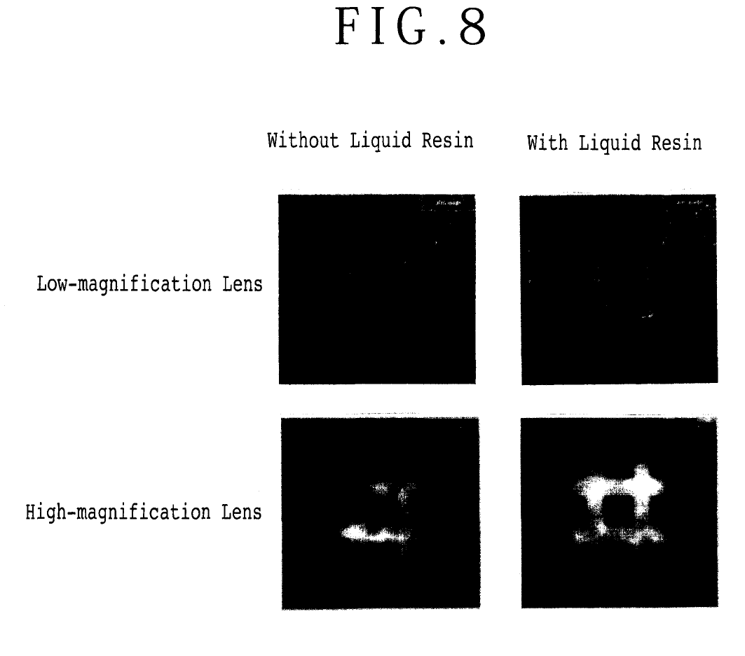

As shown in FIG. 6, a pattern in a sapphire wafer was detected from the side of an exposed surface of the wafer, the results being shown as an example in FIG. 8. In this case, the thickness of the sapphire wafer was 200 μm, the rugged exposed surface of the sapphire wafer was coated with PVA (polyvinyl chloride) adopted as the liquid resin, and the resin was cured to form a coating film about 1.0 μm in thickness. As shown in FIG. 8, in the case where the pattern is imaged from the exposed surface side of the sapphire wafer without coating the surface with a liquid resin, the image of the pattern is blurred, irrespectively of the magnifying power of the lens. On the other hand, in the case where the exposed surface of the sapphire wafer is coated with the liquid resin to flatten the surface, the pattern can be imaged more clearly than in the case of not coating the exposed surface with the liquid resin, irrespectively of whether the lens used is a low-magnification lens or a high-magnification lens.

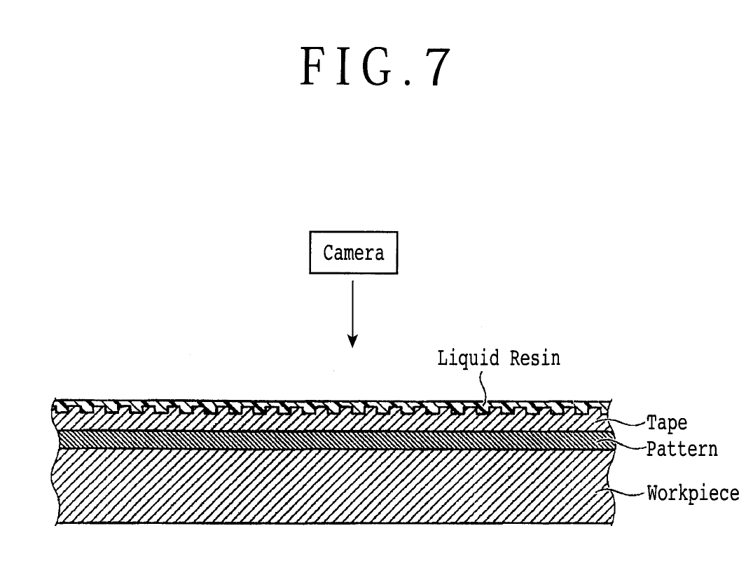

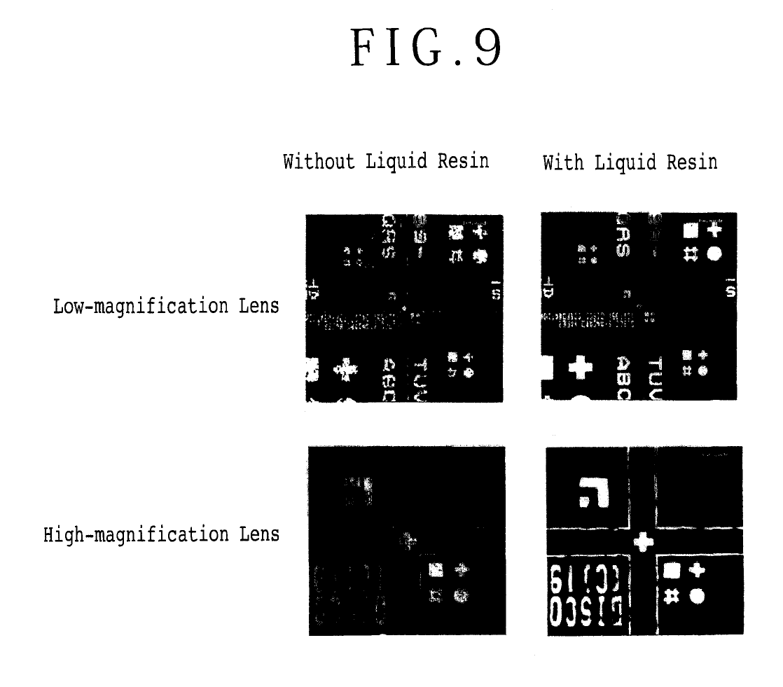

As shown in FIG. 7, a pattern in a workpiece was detected through a satin-finished surface of a tape which constitutes an exposed surface, the results being shown in FIG. 9. Incidentally, the tape used was a 90 μm-thick tape of PVC (polyvinyl chloride), and the satin-finished surface of the tape was coated with PVA used as the liquid resin, followed by curing to form a coating film about 1.0 μm in thickness. In this case also, as shown in FIG. 9, if the pattern in the workpiece is imaged from the exposed surface side of the tape without coating the surface with a liquid resin, the image of the pattern would be blurred, irrespectively of the magnifying power of the lens. On the other hand, in the case where the satin-finished surface of the tape is coated with the liquid resin to flatten the surface, the pattern can be imaged more clearly than in the case of not coating the exposed surface with the liquid resin, irrespectively of whether the lens used is a low-magnification lens or a high-magnification lens.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A method of detecting an object of detection formed on a non-exposed surface of a workpiece having a rugged exposed surface, the detection being conducted from the exposed surface side of the workpiece by use of imaging means, the method comprising:
a flattening step of coating the exposed surface of the workpiece with a liquid resin transmissive to wavelength of light to be detected by the imaging means and curing the resin so as to flatten the exposed surface of the workpiece; and
a detecting step of detecting the object of detection formed on the non-exposed surface of the workpiece by use of the imaging means from the exposed surface side of the workpiece coated with the liquid resin which is cured, after the flattening step.

2. The method according to claim 1, wherein the imaging means is composed of infrared imaging means.
